(19) United States
(12) Patent Application Publication
(10) Pub. No.: US 2008/0265014 A1
(43) Pub. Date: Oct. 30, 2008

(54) Credit Relationship Management

(75) Inventors: Kellie Smirnoff, Jacksonville, FL (US); Linda Wells, Palm Coast, FL (US); Geoffrey Deckelbaum, Atlanta, GA (US); Thomas Gareau, Charlotte, NC (US); Maria Kurtz, Charlotte, NC (US); Gary Smith, Charlotte, NC (US); Amanda Warfield, Charlotte, NC (US); John Finkbeiner, Cornelius, NC (US); Allison Van Dillen, Mableton, GA (US); Michael Jacobs, Harrisburg, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 11/742,007

(22) Filed: Apr. 30, 2007

(51) Int. Cl. G06F 17/00

(52) U.S. Cl. 235/375

(57) ABSTRACT

Systems and methods are disclosed for managing a credit relationship and determining whether to extend credit to a customer. A plurality of user devices may be linked and provided shared access to a customer account over a computer network to assist in streamlining an underwriting decision in a line of business. A customer account may be approved by entering customer data and credit data into a data file, performing a credit decision on the data file, and approving the data file. The approval process may comprise a plurality of modules including a customer module, a credit module, a review module, an exposure module, a relationship module, an approval module, and optionally a tracking module and/or a maintenance module. Further, users or computing devices may be permitted to enter data, alter data, view data, or some combination of viewing, entering, and altering data within one or more of the modules.

### FIELD OF TECHNOLOGY

Aspects of the disclosure relate to establishing and maintaining a credit relationship. More specifically, aspects of the disclosure relate to approving a customer for a credit relationship and relate to determining whether to extend credit to a customer.

### BACKGROUND

Financial institutions provide a variety of financial services to their customers that establish a credit relationship between the financial institution and the customer, such as loans, lines of credit, and mortgages. The financial institution typically performs an underwriting process to establish the credit relationship with the customer. Underwriting refers to the process that an entity, such as a financial service provider (bank, insurer, investment house), uses to perform the process of providing access to their products like providing equity capital, insurance, or credit to a customer. As part of the underwriting process, financial institutions develop approval processes that determine whether a customer's account presents a good financial risk, e.g., the benefits to the financial institution outweigh the risks associated with the approval of the customer. A traditional approval process requires information that is provided from the customer along with the customer's credit history and information provided by other financial institutions. The information necessary to perform an approval of the customer's account often contains sensitive personal information that needs to remain confidential and be disclosed only to those employees that need to be aware of it.

Often times, the approval process requires multiple steps that may be handled by several different employees at the financial institution. Each employee working on a customer's account is provided access to the sensitive information that is disclosed in a customer's account. When employees complete a step of the approval process, they may send the document to all of the employees that are working on the customer's account or may store the documents in a common location to provide access to all of the documents related to the customer account. However, one employee may be unaware that another employee made changes to a document or failed to distribute the most recent version of the document. Customer service is crucial in maintaining a financial institution's integrity and sustainability in the industry, yet the approval process is detailed and time-consuming and may become inefficient and prone to errors.

Financial institutions also face the challenges of providing reviews of their customers' accounts for such purposes as auditing. The review process becomes very burdensome for most financial institutions because it is difficult to locate all of the necessary versions of a document and may even be difficult to locate the documents themselves. Therefore, it would be beneficial to have an approval process that provides a central location for all of the necessary documents, maintains the confidential nature of the customer's personal information, reduces the risk of error, increases the efficiency for approving a customer account, and provides reviewing information for a customer account.

### BRIEF SUMMARY

Aspects of the present disclosure address one or more of the issues mentioned above by describing a system and method for approving a credit relationship. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one example in accordance with aspects of the disclosure, a method is illustrated for determining whether to extend credit to a customer. A computer network may be provided for maintaining a customer account that is associated with determining whether to extend credit to the customer. Customer data may be received, where the customer data may be representative of information about the customer. Further, entity data may also be received, where the entity data may be representative of entities that may be involved in determining whether to extend credit to the customer. Credit data may also be received, where the credit data may be representative of terms that are associated with extending credit to the customer.

A data file may be generated that may include the customer data, the entity data, and the credit data. The data file may be stored in a computer network. A notification may be electronically sent to an entity, where the notification comprises an alert. Access to the data file may be provided within the computer network for the entity. A response to the notification may be received that includes information relating to the alert. The response may be stored in the computer network and may be associated with the data file. Then a determination may be made of whether to extend credit to a customer based on the response in the data file.

In another example in accordance with aspects of the disclosure, an apparatus for managing a credit relationship may include a memory that stores a plurality of modules comprising computer-executable instructions, a process that is configured to execute the computer-executable instructions in the plurality of modules, and a computer network that may be configured to provide shared access to at least a portion of the plurality of modules to at least two computing devices. The plurality of modules may include a customer module that is configured to manage customer data relating to the credit relationship, a credit module that is configured to manage credit data about the credit relationship, a review module that is configured to manage review data about the credit relationship, an exposure module that is configured to manage exposure data about the credit relationship, a relationship module configured to manage relationship data about the credit relationship, and an approval module configured to manage approval data about the credit relationship. The determination of whether to approve the credit relationship may be based on the customer data, the credit data, the review data, the exposure data, the relationship data, and/or the approval data.

In yet another example, an underwriting system may be provided that includes a plurality of computing devices that each contains software for creating a data file, a receiver for receiving the data file, a server including memory that stores computer-executable instructions, and a processor for executing the computer-executable instructions. The server and processor may perform a method including receiving data from one of the plurality of computing devices over a computer network, storing the data in the data file that is associated with a customer account, and storing the data file that is accessible to the plurality of computing devices. The computing device, receiver, and server form an underwriting system that is capable of generating documentation for approval of a customer credit. The underwriting system may be implemented in accordance with aspects of the invention to perform methods disclosed herein.

### BRIEF DESCRIPTION OF THE DRAWINGS

The present disclosure is illustrated by way of example and not limited in the accompanying figures in which like reference numerals indicate similar elements and in which:

FIG. 1 illustrates a schematic diagram of a general-purpose digital computing environment in which certain aspects of the present invention may be implemented.

FIG. 2 depicts an underwriting system for managing a customer account, in accordance with at least one aspect of the present invention.

FIG. 3 shows a flowchart illustrating a method of determining whether to extend credit to a customer, in accordance with at least one aspect of the present invention.

### DETAILED DESCRIPTION

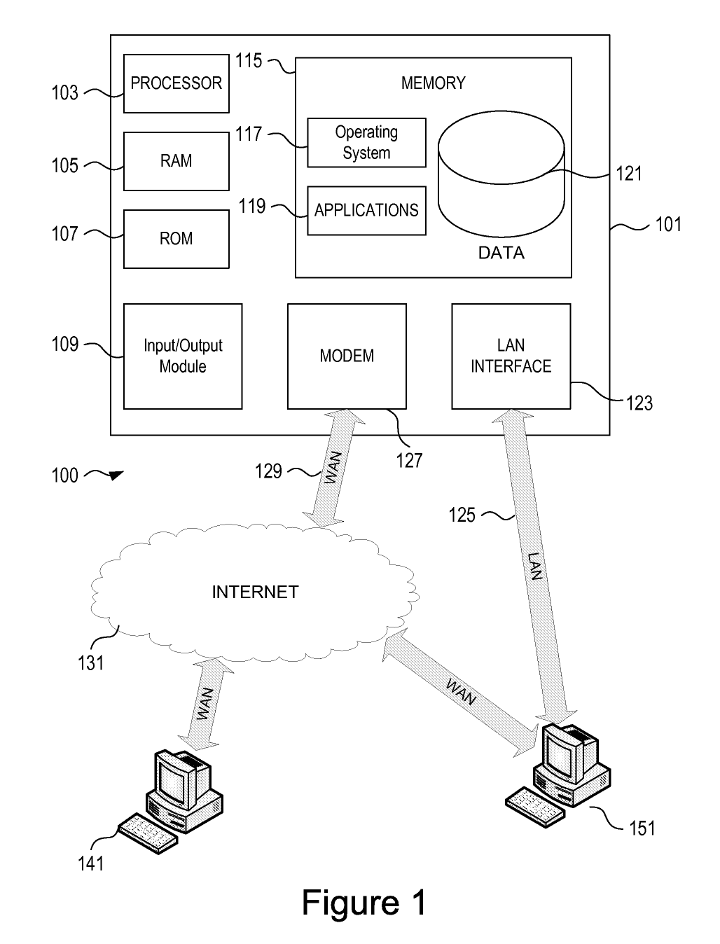

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 101. Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of the computer executable instructions for computer 101 may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the invention may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

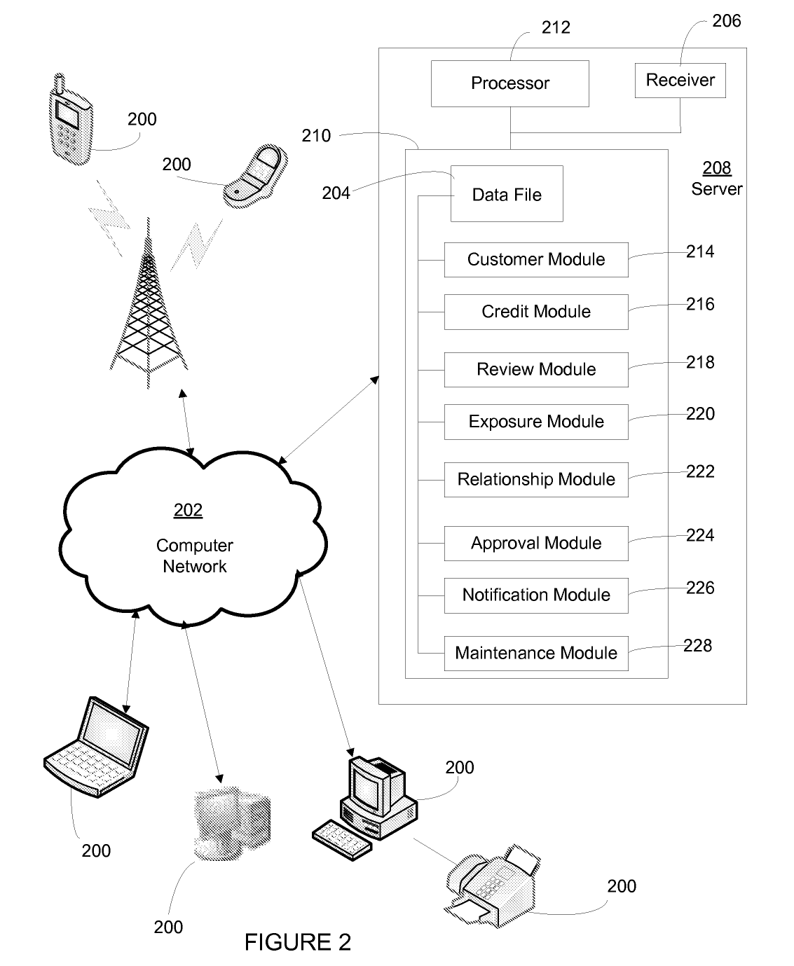

FIG. 2 illustrates an operating environment for a method of determining whether to extend credit to a customer, in accordance with at least one aspect of the present invention. A financial institution may determine whether to deny or approve an extension of credit to a customer by proceeding through an underwriting system. The financial institution may decide to approve the customer and extend the customer credit or may decide to deny the customer credit based upon one or more of the methods and/or systems described herein.

A plurality of computing devices 200 may be coupled to a computer network 202 and may be able to communicate with one another. The computing device 200 may be any electronic device that accepts and processes information according to a set of instructions. The computing device 200 may have a user interface that is capable of producing a visual display. A plurality of computing devices 200 may be coupled to the computer network 202 and may communicate with each other over the computer network 202.

Each of the plurality of computing devices 200 may contain software for creating a data file 204. The software may be a set of detailed computer-executable instructions for the computing devices 200 to execute. The software provides the computing devices 200 with the ability to create a data file 204. The data file 204 may contain multiple individual files of information that may each correspond to an individual document. For example, if the underwriting system requires that several forms be completed, each form may be separately contained within the data file 204 and may be separately accessed by a computing device 200. Additionally, reports may be generated from each individual document in the data file 204 or from the data file 204 in its entirety.

The software may be capable of permitting more than one computing device 200 or user (not shown) to access the data file 204 at the same time. For example, two computing devices 200 may be allowed to access the stored data file 204. In accordance with at least one aspect of the present invention, one of the computing devices 200 (or the user of that computing device 200) may be assigned a first privilege level and the second computing device 200 (or the user of that computing device 200) may be assigned a second privilege level that is different than the first privilege level. The first privilege level may represent a user (not shown) that may have access to the data file 204 but may not be provided the ability to alter or add data to the data file 204. This type of access may be referred to as read access to the data file 204. The second privilege level may represent a user that may be allowed the ability to both access the data file 204 and alter and add data to the data file 204. This type of access may be referred to as write access to the data file 204. A third user may be assigned a third privilege level that represents a user that is assigned the responsibility of making a final approval or denial decision regarding whether to extend credit to a customer or whether to underwrite a financial relationship between the financial institution and a customer.

Referring back to FIG. 2, a receiver 206 may be included in the underwriting system, where the receiver 206 receives data. The data may be received directly into the data file 204, or may be processed after being received and then saved into the data file 204. Ultimately, at least a portion of the data (or the resulting data after being processed) is received into the data file 204. The data may be customer data and/or credit data, as described in detail below. One of skill in the art will appreciate that the data may contain all information that a financial institution needs in order to determine whether to extend credit to a customer.

The receiver 206 may be any device that is capable of receiving an electrical signal. Moreover, in some examples, the receiver 206 may be a device that is also capable of transmitting the electrical signal from one location to another. For example, a receiver 206 may be input/output (I/O) hardware in a computing device 200 or server 208 that may send and receive data and store the data in a data file 204 or send the data to an intermediary element for processing.

In one example in accordance with various aspects of the invention, data that is received by the receiver 206 may be sent to a server 208. In FIG. 2, the receiver 206 is shown as being included within the server 208. The server 208 may be any shared computer that is operatively coupled to a computer network 202 that acts as a repository and distributor of data. The server 208 may be any shared computing device 200. Server 208 also may be a fast and robust computing device 200 that acts to organize and regulate data that is being transmitted to the computer network 202, from the computer network 202, and within the computer network 202. The server 208 may be accessible as a web server over the Internet or an intranet. Furthermore, the server 208 may be embodied as a server farm comprising multiple computers that provide a scaleable and/or secure architecture. For example, one or more modules (214, 216, 218, 220, 222, 224, 226, 228) may be located on different computers in the server farm to distribute processing load among the various machines. One of ordinary skill in the art will appreciate these and other aspects of the server 208 after review of the entirety disclosed herein.

The server 208 may include memory 210 for storing computer-readable instructions and a processor 212 for executing the computer-executable instructions. The computer-executable instructions may be data in the form of program source code that is capable of modifying the data file 204. The computer-executable instructions may be a series or sequence of instructions for a computing device that are typically in the form of a programming language such as C++, Java, SQL, or the like. A person of ordinary skill in the art will appreciate that various computer programming language may be used to create the computer-executable instructions, and the invention is not limited to the numerous programming languages listed above.

Memory 210 may be a portion of the server 208 that stores data or other instructions for later use. The memory 210 may be retained or lost when power is lost to the system. Memory 210 may provide access to a data for a user or computing device 200 to access and change a data file 204 or may only provide access to the data file 204. These and other aspects of the memory 210 will be apparent to one of ordinary skill in the art in view of the below description.

The processor 212 may be capable of executing the computer-executable instructions. The computer-executable instructions may be executed by the processor 212 after they have been stored in the memory 210. The processor 212 may be a centralized element within a computing system that is capable of performing computations. For example, the processor 212 may perform the computations that are described in the computer-executable instructions and then execute the computer-executable instructions. In accordance with at least one aspect, the computer-executable instructions may include data describing changes to the data file 204 that were made by a user or computing device 200 over the computer network 202. The server 208 stores the data in the data file 204 that is associated with a customer's account. The data file 204 may be stored in the memory 210 so that it may be accessible to a plurality of computing devices 200 and/or users. Together, the computing devices 200, receiver 206, and the processor 212, operate as an underwriting system for a financial institution, wherein the underwriting system is capable of approving credit for a customer.

The data that is stored in the data file 204 may include customer data that may be information that relates to the customer. Customer data may include the customer's name, address, social security number, contact information, income, a unique customer account identifier, and/or the like. The customer oftentimes provides the customer data to the financial institution to begin the process of applying for credit. The financial institution may utilize the customer information to properly identify the customer. Further, the customer information may be used to verify that the customer's identity is valid and provide the financial institution with the ability to properly perform additional research on a customer such as running a criminal history, determining whether a customer is involved in lawsuits, verifying a customer's employment history, and the like. A financial institution may require that a complete disclosure of the customer data be obtained before proceeding with the process of determining whether to extend credit to a customer.

The customer data may be stored in the data file 204 by a user from within the financial institution or by the customer. Although the customer may be allowed to store customer data in the data file 204, the financial institution most likely will independently verify the customer data. Due to the sensitive and confidential nature of the customer data, financial institutions may take security precautions to prevent unauthorized access to the customer data. A log-on identification and a password may be required to access the customer account and/or the customer data may be encrypted before it is allowed to be sent over the computer network.

The data that is stored in the data file 204 may also include entity data that may be information relating to the entities that are involved in determining whether to extend credit to the customer. Entity data may include information relating to the entity that is extending the credit to the customer such as information on the type of credit being extended, prerequisites or requirements of the entity that must be met before credit is extended, a history of the customer's relationship with the entity, and the like. Entity data may also include information on the users or entities that make decisions regarding the approval process when determining whether to extend credit to a customer. For example, within a financial institution several lines of businesses may extend credit to a customer. Each line of business may have different procedures for extending credit to a customer. A financial institution may implement underwriting in such lines of businesses for products such as real estate loans, lines of credit, automobile or other personal loans, student loans, and the like. Each extension of credit may represent different risks to the financial institution.

The data that is stored in the data file 204 may include credit data that may be information relating to the credit of a customer and/or different credit options/packages that are available to customers in general. Credit data may include information relating to a customer's credit score, credit history, credit risk, and the like. Sometimes, a financial institution may offer different programs or may extend credit with differing terms (i.e. annual percentage rate, time to repay, etc.) depending, in part, on a customer's credit data. A customer's credit score may be obtained by an independent agency that performs statistical analysis of a customer's credit files. The financial institution may utilize the credit score as one indication of the risk associated with extending credit to a customer. This information is most frequently obtained from a credit bureau or credit agency. A customer's credit history may be a complete or incomplete record of a customer's borrowing, ability to repay debts, whether the customer has ever been in bankruptcy, and the like. The credit risk relates to the risk of loss that may be suffered by the financial institution if the customer defaults on the extension of credit.

A customer may wish to apply for credit in multiple lines of businesses or may wish to apply for multiple credit accounts within one line of business. In this situation, a data file 204 may contain one entry of customer data and multiple entries for entity data that correspond to each extension of credit. The data may be linked between the lines of business and between multiple accounts within the same line of business so that the computing device 200 and/or user may be required to enter the data one time rather than repeatedly entering the data under these circumstances.

Some of the data stored in data file 204 may be common to the customer data, the entity data, and the credit data or some combination of the data elements. Data that is common between two or more of the data elements may be linked so that it appears and is stored in every data element without repeating the process of entering the data into each element for which it is desired. For example, a customer's income may be entered into the customer data and the credit data. When the customer's income is stored in the customer data, it may be linked to the credit data and stored there as well. Therefore, the customer's income may be entered once, which reduces the risk of error and increases efficiency.

The data that is stored in the data file 204 may include review data that may be information relating to the process of reviewing the data file within the financial institution. The review data may also include the process of reviewing a data file 204 and/or customer account after credit has been either approved or denied. Review data may be used to assist a financial institution in performing an internal audit or an audit being conducted by an independent party. The review data may provide the financial institution with reports that present the information that is required during an audit. One of ordinary skill in the art will appreciate that a financial institution may organize and present the review data in any manner suitable to provide useful reports to the financial institution and/or a third party.

Review data may also be customizable to a customer based on the customer's needs. For example, a financial institution may extend credit to a private corporation that wishes to conduct an Initial Public Offering (IPO) of corporate shares. The review data may include information that will assist the private business entity in preparing for the IPO. One of ordinary skill in the art will recognize that customized data is not unique to the review data portion of the data file. The data in any portion of the data file 204 may be customized by the financial institution to meet the customer's needs.

The data that is stored in the data file 204 may additionally include maintenance data that contains information on maintaining the customer's account. Maintenance data may include covenant compliance verification, financial statement tracking, yearly reports, quarterly reports, and the like. The maintenance data may also be used to send reminders to the users of pending activity.

Referring again to FIG. 2, in accordance with various aspects of the invention, a server 208 for managing a credit relationship is disclosed. The server 208 for managing the credit relationship includes memory 210 for storing a plurality of modules and at least one data file 204, and a processor 212 configured to execute computer-executable instructions. The server 208 may provide shared access to at least a portion of the plurality of modules to at least two computing devices 200 over a computer network 202. The credit relationship may be between a financial institution and a customer. The financial institution may extend credit to the customer based upon an analysis of the customer's account.

As illustrated in FIG. 2, the server 208 for managing the credit relationship includes memory 210 for storing a plurality of modules. Memory 210 may be a portion of the server 208 that stores data or other instructions for later use, as described in detail throughout this disclosure. The computer-executable instructions may be a series or sequence of instructions for a computing device 200, also described in detail throughout this disclosure. The processor 212 may be configured to execute the computer-executable instructions that may be used to determine the credit relationship. Such computer-executable instructions may be located (e.g., physically or logically) in modules in the memory 210. The computer network 202 may be any network that interconnects users and/or computing devices 200 and is capable of allowing each user to communicate with one another. According to at least one aspect of the invention, the computer network 202 may provide shared access to two computing devices 200 to at least a portion of the data in the plurality of modules. Shared access may be two or more computing devices 200 being coupled to the computer network 202 and/or being able to communicate with each other and/or access, change, and add data to a data file 204.

Aspects of the invention may be described in the general context of computer-executable instructions, such as program modules, executed by one or more computers or other devices. The plurality of modules may include a customer module 214, a credit module 216, a review module 218, an exposure module 220, a relationship module 222, and an approval module 224. Generally, program modules include routines, programs, objects, components, data structures, etc. that perform particular tasks or implement particular abstract data types. Typically the functionality of the program modules may be combined or distributed as desired in various embodiments. For example, modules may be logically divided among various files and/or processors. Furthermore, one or more of the modules may be optional and may be omitted in accordance with various embodiments of the invention.

The customer module 214 may be configured to manage customer data relating to the credit relationship. The customer module 214 may include such data about the customer as the customer's name, address, social security number, contact information, income, a unique customer account identifier, and the like. One skilled in the art will appreciate that the customer data may include information about the customer that is desirable to the financial institution for approving a credit relationship.

The credit module 216 may be configured to manage credit data about the credit relationship. The credit module 216 may include such data as a customer's credit score, credit history, credit risk, and the like. Additional information may be included in the credit module 216 that relates to the customer's credit data.

The review module 218 may be configured to manage review data about the credit relationship. The review module 218 may include such data as information relating to the process of reviewing the data file within the financial institution and the process of reviewing a data file 204 and/or customer account after a customer has been either approved or denied the credit. Additional information may be included in the review module 218 that may be needed or contemplated by the financial institution.

The exposure module 220 may be configured to manage exposure data about the credit relationship. The exposure data may include information relating to an analysis of the risk of exposure by the financial institution. The financial institutions may run objective and/or subjective analysis of a customer's credit relationship to determine whether to approve a credit relationship. Objective analysis may include statistical analysis and subjective analysis may include analysis of past and current business activities between the financial institution and the customer. One of ordinary skill will appreciate that the exposure data may vary depending on the nature of the entity that is approving the credit relationship, the terms of the credit relationship, and the like.

The exposure module 220 and the review module 218 may be integrated with the credit module 216. The credit module 216 may act as a central module that contains both the exposure module 220 and the review module 218 and provides exposure data and review data through the credit module 216. In this case, the exposure data and review data may be integrated into the credit data or may be a separate portion of the credit data.

The relationship module 222 may be configured to manage relationship data about the credit relationship. Relationship data may include information relating to the relationship between the financial institution and the customer, financial or business information obtained from other financial institutions about the customer applying for a credit relationship, and the like. The relationship data may provide the financial institution with the ability to account for relationships that the customer has with non-financial institutions as well. Additional information that is associated with the relationship between the customer and the financial institution may be contemplated and incorporated into the relationship module 222.

The approval module 224 may be configured to manage approval data about the credit relationship. The approval data includes information relating to the approval process, the status of the approval, the final approval, etc. The approval data may be used to provide updates to the customer regarding the status of the credit relationship. It may also be used internally at the financial institution to provide status reports to users that are approving a credit relationship. The approval data may be determined by objectively or subjectively analyzing the customer module 214, the credit module 216, the review module 218, the exposure module 220, and the relationship module 222. One of ordinary skill in the art will appreciate that the approval module 224 may include additional information relating to the approval process, approval status, and the final approval itself. The apparatus for managing a credit relationship may also include a notification module 226 that is configured to notify a user device of a status of the credit relationship.

The apparatus for managing the credit relationship may also include a maintenance module 228 that is configured to manage maintenance data about the credit relationship. Maintenance data may include information on maintaining the customer's account. Maintenance data may also include monthly statements, yearly reports, quarterly reports, mailing of coupon payment books, customer events, and the like. It will be appreciated by one of skill in the art that additional information may be contemplated to be included in the maintenance data.

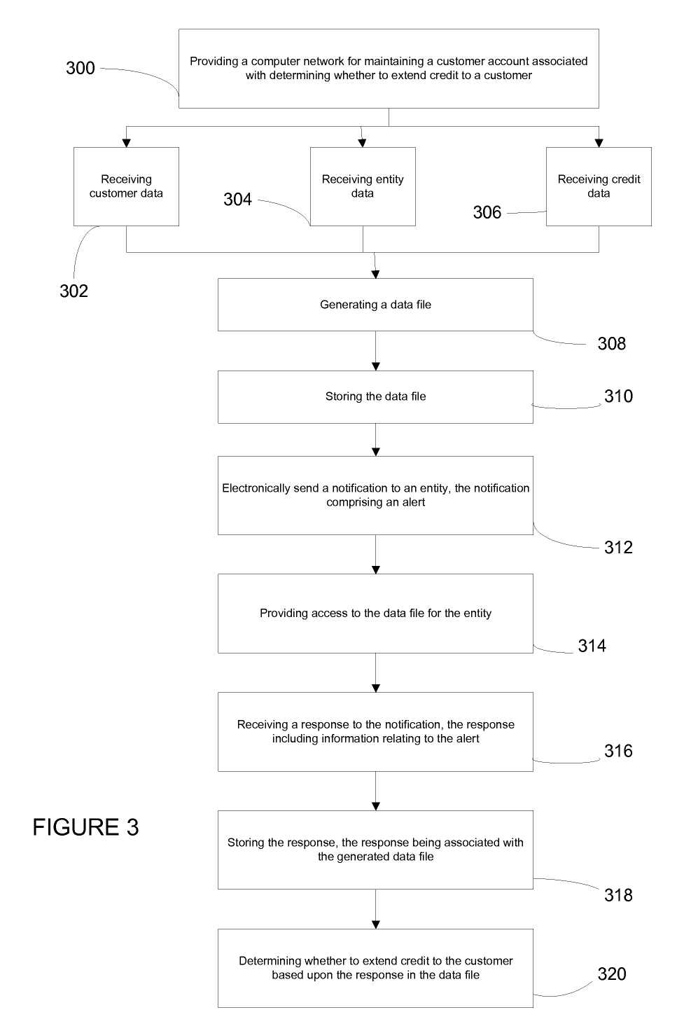

FIG. 3 shows an illustrative method of determining whether to extend credit to a customer in accordance with at least one aspect of the present invention. At step 300, the method provides a computer network for maintaining a customer account that is associated with determining whether to extend credit to the customer. The computer network receives customer data that is related to customer information in step 302, receives entity data that is related to the entities that are involved in determining whether to extend credit to the customer in step 304, and receives credit data that is related to the terms that are associated with extending credit to the customer in step 306. A data file including the customer data, the entity data, and the credit data is generated in step 308 and the data file is stored in the computer network in step 310. After the data file is stored in the computer network in step 310, a notification is sent electronically to at least one entity to notify the entity that the data file may be accessed in step 313. The notification may identify a decision that needs to be made on the data file. The entity may be provided access to the data file within the computer network in step 314. A response to the notification that is associated with the data file may be received in step 316 and the response may be stored within the computer network in step 318. A decision of whether to extend credit to the customer may be based upon the response and the data file in step 320.

The computer network that is provided in step 300 may be any network that interconnects user devices and is capable of allowing each user to communicate with one another. For example, each user may be an employee within the financial institution. In another example, the users may comprise of a server, a group of employees within the financial institution, and the customer. Here, the customer may have access to the data file to enter personal information or obtain status information on whether credit has been extended to the customer.

The computer network provides access to files that may be shared between the user devices. Additionally, the computer network may be public or private and may be wired or wireless. The user devices that are connected to the computer network may be any electronic device that is capable of connecting to the computer network and transmitting data over the network. Further, the user devices are capable of receiving data for entry into a data file associated with the customer.

Customer data representative of information on the customer may be received at step 302. The customer data may include information such as the customer's name, address, social security number, contact information, income, or any other piece of customer information, as described in greater detail above. One of ordinary skill in the art will recognize that the customer data may be any information about the customer that may be needed by a financial institution to extend credit to the customer.

Further, entity data representative of information on the entities involved in determining whether to extend credit to the customer may be received at step 304. Entity data may include information about a line of business within the financial institution that is extending the credit to the customer or may be information, as described in detail above. The entity data may also include requirements and/or prerequisites of a line of business that may be placed upon a customer when the financial institution is determining whether to extend the credit to the customer, also described above.

Credit data may be received at step 306 that is associated with determining whether to extend credit to a customer. The credit data may include such information as a customer's credit score and credit history, as described above. A person of ordinary skill in the art will appreciate that additional types of data may be received when determining whether to extend credit to a customer, also described above.

A data file may be generated that includes the customer data, the entity data, and the credit data at step 308. The data file may be a form that is representative of a portion of the approval process. The data file may also be a set of steps through which a customer must go in order to be extended credit by the financial institution. Such steps may include filling out an initial application, providing financial information, passing a credit history screening, and the like (not shown). The data file may place a requirement on each step to obtain a score that is acceptable to the line of business that is extending the credit to the customer. Some steps may be progressive and require that a customer obtain an acceptable score on a preliminary step before the financial institution will consider the customer at the intermediary step. Other steps may be fulfilled on a threshold basis. For example, when the customer's information meets or exceeds a threshold, then the associated step will be considered to be satisfied by the customer. A person of ordinary skill in the art will appreciate that steps are not required by this invention and further, that all of the information in a data file may be considered, as a whole, in determining whether to extend credit to a customer.

When information has been stored in a data file, a notification may be electronically sent to an entity at step 312. The notification may be in the form of an email, facsimile, text message, telephone call, voicemail, or any other status alert that notifies the entity that information has been added, altered, or accessed in the data file. A text message may be any plain text electronic message that is sent between devices. Text messaging may include short message service (SMS), which is a plain text message that may be sent to and from digital devices over a cellular network. However, one of skill in the art will appreciate that a text message may be any notification that is in plain text and is not limited to SMS. Further, the notification step may be a telephone call that is made to a user or a voicemail message that may be left for a user.

The notification that may be electronically sent step 312 to an entity may contain information describing the type of action that was performed on the data file. For example, when a user makes a change to a document in the data file, a change notification may be sent. When a customer's account has been approved or denied credit, then an approval notification or a denial notification may be electronically sent, respectively. Further, an access notification may be electronically sent when the entity obtains access to the data file. For example, if a user accesses the customer's account for any reason, the entity is electronically notified that the customer's account was accessed. One of skill in the art will appreciate that any necessary type of notification may be used to alert the entity and/or users that are part of the entity about the status of the data file.

The entity may be a human user, another data file, or an automated application. The entity may also be a group of users or a line of business within the financial institution. If multiple users are part of the entity, each user may operate in unison with each other or may operate upon the data file individually or in a group that includes a portion of the associated entity. A notification may be sent to more than one entity.

The entity may be provided access to the data file within the computer network at step 314. A privilege may be attached to an entity that restricts the entity's access to the data file. For example, a first human user and a second human user are each part of the entity. The first human user may be an account manager and the second human user may be an approver. In this case, the account manager may obtain access to the data file for purposes of entering customer data, but may not obtain access to the data file for purposes of approving the decision to extend credit to the customer, whereas the approver may have access to all portions of the data file and may perform the final approval of credit.

More than one entity may be permitted to access the data file at the same time. When multiple entities as permitted access to the data file, each entity may be assigned a privilege level in the same manner as a privilege level is assigned to multiple users within one entity. For example, a first entity may be assigned a first privilege level and a second entity may be assigned a second privilege level that is different from the first privilege level.

Although the data file may be accessed by more than one entity or more than one user or computing device, the data file may not typically be modified by multiple users or computing devices at the same time. Some financial institutions may permit more than one user or computing device and/or entity to modify the data file at a same time. However, one user and/or entity may repeat modifications performed by another user and/or entity if multiple users and/or entities are permitted to modify the data file at the same time.

Access to the data file in step 314 may be provided over the Internet or over an intranet. Security measures may be taken to protect unauthorized access to the data file such as requiring a password and encrypting data flowing over the network. A virtual private network may be used to provide security when a user wishes to remotely access the data file over a private computer network.

Referring back to FIG. 3, a response to the notification may be received that includes an answer at step 316. The response may be generated automatically or manually. The response may also be sent that notifies the entity of a user's status. For example, if a user is not active, a response may be sent that notifies the entity of the user's inactive status.

Further, a response to the notification may be received at step 316 when the entity acts upon the data file after receiving the notification. If the entity completes one portion of deciding whether to extend credit to a customer, then a response may be received that indicates that the next portion is assigned to a particular user. For example, an account manager may be responsible for obtaining the customer data from the customer. Once the account manager has properly entered all of the customer data, then a notification may be sent to the entity. A response may be sent to the entity assigning the step of obtaining information relating to the type of credit for which the customer is applying. Additionally, a response may be sent to the entity to determine the credit history of a customer. Ultimately, each response may be stored in the computer network and associated with the data file at step 318. Because each response is associated with the data file, the data file always contains the most current and accurate versions of the data file. By storing each response on the computer network, any user of that is part of the entity may have access to the most current and accurate versions of the data file.

Referring back to FIG. 3, the financial institution determines whether to extend credit to a customer based upon receiving the response and the data file at step 320. The response may include a plurality of responses, as described above. The response may be decided manually or automatically, depending upon the needs of the line of business and the restrictions placed upon extending credit to the particular customer.

One of ordinary skill in the art will recognize that the invention may be practiced by any entity that chooses to extend credit to a customer. Further, the invention may be used to provide credit or underwriting services to any type of customer regardless of whether the customer is a business entity or an individual. The invention is not limited to extending credit to customers for a specific group of services or for a particular type of product.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Of course, the methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules, or by utilizing computer-readable data structures.

We claim:

1. A method for determining whether to extend credit to a customer, comprising:
providing a computer network for maintaining a customer account associated with determining whether to extend credit to a customer;
receiving customer data representative of information about the customer;
receiving entity data representative of entities involved in determining whether to extend credit to the customer;
receiving credit data representative of terms associated with extending credit to the customer;
generating a data file including the customer data, the entity data, and the credit data;
storing the data file in the computer network;
electronically sending a notification to an entity, the notification comprising an alert;
providing access to the data file within the computer network for the entity to access the data file;
receiving a response to the notification, the response including information relating to the alert;
storing the response in the computer network, the response being associated with the data file; and
determining whether to extend credit to the customer based upon the response and the data file.

2. The method of claim 1, wherein the computer network is accessible through a webpage on the Internet.

3. The method of claim 1, wherein the computer network is accessible through a webpage on an intranet.

4. The method of claim 1, wherein the customer is capable of entering the customer data to the data file, and wherein the customer is provided access to the data file.

5. The method of claim 1, wherein the entity comprises a first user and a second user, and wherein the first user has a first privilege level and the second user has a second privilege level that is different from the first privilege level.

6. The method of claim 1, wherein the data file further comprises review data relating to a review process for determining whether to extend credit to the customer.

7. The method of claim 1, wherein the data file further comprises maintenance data that is representative of maintenance that is to be performed upon the customer account.

8. The method of claim 1, wherein more than one entity is sent the notification.

9. The method of claim 1, wherein more than one entity is permitted to access the data file at the same time.

10. The method of claim 9, wherein only one entity is permitted to modify the data file at a time.

11. The method of claim 1, wherein the notification is by at least one of electronic mail, facsimile, text message, telephone call, and voicemail.

12. The method of claim 1, further comprising denying the credit to the customer.

13. The method of claim 1, further comprising approving the credit to the customer.

14. A computer-readable medium comprising computer-executable instructions to perform a method, comprising:
receiving customer data representative of information about a customer;
receiving entity data representative of entities involved in determining whether to extend credit to the customer;
receiving credit data representative of terms associated with extending credit to the customer;
generating a data file including the customer data, the entity data, and the credit data;
storing the data file;
electronically sending a notification to an entity;
providing access to the data file for the entity;
receiving a response to the notification;
storing the response, the response being associated with the generated data file; and
determining whether to extend credit to the customer based upon the response and the data file.

15. An apparatus for managing a credit relationship, comprising:
a memory storing a plurality of modules comprising computer-executable instructions, the plurality of modules including:
a customer module configured to manage customer data relating to the credit relationship;
a credit module configured to manage credit data about the credit relationship;
a review module configured to manage review data about the credit relationship;
an exposure module configured to manage exposure data about the credit relationship;
a relationship module configured to manage relationship data about the credit relationship; and
an approval module configured to manage approval data about the credit relationship; and
a processor configured to execute the computer-executable instructions in the plurality of modules to determine whether to approve the credit relationship based on the customer data, the credit data, the review data, the exposure data, the relationship data, and the approval data;
the plurality of modules configured to provide shared access to at least a portion of the customer data, the credit data, the review data, the exposure data, the relationship data, and the approval data.

16. The apparatus of claim 15, further comprising a notification module configured to notify a computing device of a status associated with approving the credit relationship.

17. The apparatus of claim 15, wherein the exposure module and the review module are integrated with the credit module.

18. The apparatus of claim 15, wherein the approval data is determined by subjectively analyzing the customer module, the credit module, the review module, the exposure module, and the relationship module.

19. The apparatus of claim 15, further comprising creating a maintenance module configured to manage maintenance information about the credit relationship.

20. The apparatus of claim 15, wherein a plurality of user devices are coupled to the computer network including a first user device and a second user device, the first user device having a first privilege level and the second user device having a second privilege level that is different from the first privilege level.

21. The apparatus of claim 15, wherein a plurality of user devices are coupled to the computer network, and wherein more than one of the user devices may access the customer account at the same time.

22. An underwriting system for managing a customer account, comprising:
a plurality of computing devices, each of the plurality of computing devices containing software for creating a data file associated with the customer account;
a receiver for receiving data; and
a server comprising memory storing computer-executable instructions, and a processor for executing the computer-executable instructions to perform a method, comprising:
receiving data from one of the plurality of computing devices over a computer network;
storing the data in the data file associated with the customer account;
storing the data file so that the date file is accessible to the plurality of computing devices;
wherein the computing device, receiver, and server form an underwriting system that is capable of generating documentation for approval of a customer credit.

23. The underwriting system of claim 22, wherein the data includes customer data.

24. The underwriting system of claim 23, wherein the customer data includes credit data.

25. The underwriting system of claim 22, wherein the software is capable of permitting more than one of the user devices to access the data file at the same time.

26. The underwriting system for approving a customer account of claim 22, wherein the data file may be accessed by the plurality of computing devices over a computer network.

27. The underwriting system for approving a customer account of claim 22, wherein a first user has a first privilege level and a second user has a second privilege level that is different from the first privilege level.
